(19) United States
(12) Patent Application Publication
(10) Pub. No.: US 2026/0121056 A1
(43) Pub. Date: Apr. 30, 2026

(54) CROSSLINKING BINDER FOR ANODE OF SECONDARY BATTERY, ANODE MIXTURE, ANODE AND SECONDARY BATTERY

(71) Applicant: KOREA KUMHO PETROCHEMICAL CO., LTD., Seoul (KR)

(72) Inventors: Jeong-Geun KIM, Daejeon (KR); Young Kyou KIM, Daejeon (KR); Hye Ryeong YOON, Seoul (KR)

(73) Assignee: KOREA KUMHO PETROCHEMICAL CO., LTD., Seoul (KR)

(21) Appl. No.: 19/367,892

(22) Filed: Oct. 24, 2025

(30) Foreign Application Priority Data
Oct. 24, 2024 (KR) 10-2024-0146789

(51) Int. Cl. H01M 4/62; C08G 81/02; H01M 4/38

(52) U.S. Cl. CPC H01M 4/622; C08G 81/025; H01M 4/386

(57) ABSTRACT

One embodiment of the present specification provides a binder for a secondary battery anode, comprising an aromatic vinyl-conjugated diene-based rubber crosslinked by polyalkylene glycol.

### TECHNICAL FIELD

The present specification relates to a crosslinked binder for a secondary battery anode, an anode mixture for a secondary battery, and an anode and a secondary battery including the same.

This application claims priority to and the benefit of Korean Patent Application No. 10-2024-0146789 filed in the Korean Intellectual Property Office on Oct. 24, 2024, and the entire contents of which are incorporated herein by reference.

### BACKGROUND ART

Secondary batteries capable of charging and discharging are being used not only in small electronic devices such as mobile phones and laptops, but also in large transportation means such as hybrid vehicles and electric vehicles.

Accordingly, the development of secondary batteries having higher stability and energy density is actively progressing.

Conventional lithium-ion batteries are composed of a carbon-based anode, an electrolyte containing an organic solvent, and a lithium oxide cathode. During charging, lithium ions exit the cathode, move through the electrolyte to the carbon-based anode, and during discharging, the reverse of the charging process proceeds.

Accordingly, as the binder, a polymer material that does not react with lithium and can stably fix the electrode active material to the electrode current collector is mainly used, and in particular, polyacrylic acid (PAA) or carboxymethyl cellulose (CMC) is generally used.

However, recently, the lithium-ion battery market is researching and developing new electrode active materials with the aim of achieving high capacity and high power, and among them, silicon-based electrode active materials are receiving attention.

These silicon-based electrode active materials can implement a capacity of about 4,200 mAh/g, which is 10 times or more higher than that of natural graphite. However, as charging and discharging are repeated, substitution and desubstitution of lithium ions occur, and a volume expansion of about 300˜400% occurs, which is known to cause problems such as degradation of the binding force with the binder, poor contact with the electrode, and degradation of battery cycle characteristics.

Due to this, there is difficulty in using pure silicon metal as an anode active material, and currently, nano-silicon or silicon oxide is mixed with graphite and used at a certain ratio or less.

Therefore, to implement high-capacity, high-performance, and long-lifespan secondary batteries, it is necessary to increase the content of silicon in the anode active material, and for this, the development of an anode binder that can maintain adhesion and resilience against the volume expansion and contraction of silicon is needed.

### DISCLOSURE

### Technical Problem

The description in the present specification is intended to solve the problems of the aforementioned prior art, and one purpose of the present specification is to provide a binder for a secondary battery anode that is excellent in adhesion and resilience against the volume expansion and contraction of silicon in a state of being wetted by an electrolyte, and thus is excellent in ion conductivity, rate capability, and lifespan characteristics.

Another purpose of the present specification is to provide an anode mixture and an anode for a secondary battery that can implement a high-capacity, high-performance, and long-lifespan secondary battery.

Another purpose of the present specification is to provide a high-capacity, high-performance, and long-lifespan secondary battery.

### Technical Solution

According to one aspect, a binder for a secondary battery anode is provided, which includes an aromatic vinyl-conjugated diene-based rubber crosslinked by polyalkylene glycol.

In one embodiment, the polyalkylene glycol may be one selected from the group consisting of polyethylene glycol, polypropylene glycol, polybutylene glycol, polypentylene glycol, polyhexylene glycol, polytrimethylene glycol, polytetramethylene glycol, polypentamethylene glycol, polyhexamethylene glycol, and combinations of two or more thereof.

In one embodiment, the gel content of the aromatic vinyl-conjugated diene-based rubber may be 90% or more.

In one embodiment, the aromatic vinyl-conjugated diene-based rubber may be an aromatic vinyl-conjugated diene-based rubber having a core-shell structure.

In one embodiment, the core of the aromatic vinyl-conjugated diene-based rubber may include, based on the total weight of the aromatic vinyl-conjugated diene-based rubber: (a1) 1˜15 wt % of a unit derived from a conjugated diene-based monomer; (a2) 5˜20 wt % of a unit derived from an aromatic vinyl-based monomer; (a3) 0˜20 wt % of a unit derived from an ethylenically unsaturated nitrile monomer or an alkyl ester-based monomer; and (a4) 0˜20 wt % of a unit derived from an ethylenically unsaturated acid monomer.

In one embodiment, the shell of the aromatic vinyl-conjugated diene-based rubber may include, based on the total weight of the aromatic vinyl-conjugated diene-based rubber: (b1) 10˜40 wt % of a unit derived from a conjugated diene-based monomer; (b2) 20˜40 wt % of a unit derived from an aromatic vinyl-based monomer; (b3) 1˜30 wt % of a unit derived from an alkyl ester-based monomer; and (b4) 0˜10 wt % of a unit derived from an ethylenically unsaturated acid monomer.

In one embodiment, the conjugated diene-based monomer may be one selected from the group consisting of 1,3-butadiene, 2,3-dimethyl-1,3-butadiene, 2-ethyl-1,3-butadiene, 1,3-pentadiene, and combinations of two or more thereof.

In one embodiment, the aromatic vinyl-based monomer may be one selected from the group consisting of styrene, α-methylstyrene, 2-methylstyrene, 3-methylstyrene, 4-methylstyrene, 2,4-dimethylstyrene, 2,4-diisopropylstyrene, 4-propylstyrene, 4-cyclohexylstyrene, 4-(p-methylphenyl)styrene, 5-tert-butyl-2-methylstyrene, tert-butoxystyrene, 2-tert-butylstyrene, 3-tert-butylstyrene, 4-tert-butylstyrene, N,N-dimethylaminoethylstyrene, 1-vinyl-5-hexylnaphthalene, 1-vinylnaphthalene, divinylnaphthalene, divinylbenzene, trivinylbenzene, vinylbenzyldimethylamine, (4-vinylbenzyl)dimethylaminoethyl ether, vinylpyridine, vinylxylene, diphenylethylene, halogen-substituted styrene, and combinations of two or more thereof.

In one embodiment, the ethylenically unsaturated nitrile monomer may be one selected from the group consisting of acrylonitrile, methacrylonitrile, fumaronitrile, α-chloronitrile, α-cyanoethyl acrylonitrile, and combinations of two or more thereof.

In one embodiment, the alkyl ester-based monomer may be one selected from the group consisting of methyl methacrylate, ethyl methacrylate, butyl methacrylate, methyl acrylate, ethyl acrylate, butyl acrylate, and combinations of two or more thereof.

In one embodiment, the ethylenically unsaturated acid monomer may be one selected from the group consisting of acrylic acid, methacrylic acid, itaconic acid, maleic acid, fumaric acid, maleic anhydride, citraconic anhydride, styrene sulfonic acid, monobutyl fumarate, monobutyl maleate, mono-2-hydroxypropyl maleate, and combinations of two or more thereof.

In one embodiment, the aromatic vinyl-conjugated diene-based rubber crosslinked by polyalkylene glycol may be prepared by mixing the aromatic vinyl-conjugated diene-based rubber and the polyalkylene glycol in a weight ratio of 90˜99.5:0.5˜10.

According to another aspect, an anode mixture for a secondary battery is provided, which includes: the binder for a secondary battery anode; and an anode active material.

In one embodiment, the anode active material may be one or more selected from the group consisting of silicon, a silicon oxide represented by the formula SiOₓ (0.5≤x≤1.5), a silicon-based alloy, and a mixture of these with a carbon-based material.

According to still another aspect, an anode is provided, which includes: an anode mixture layer including the anode mixture for a secondary battery; and an anode current collector layer.

According to still another aspect, a secondary battery is provided, which includes: the anode; a cathode; and an electrolyte layer.

### Advantageous Effects

The binder for a secondary battery anode according to one aspect of the present specification is excellent in adhesion and resilience against the volume expansion and contraction of silicon in a state of being wetted by an electrolyte, and thus can exhibit excellent effects in ion conductivity, rate capability, and lifespan characteristics.

The anode mixture and the anode for a secondary battery according to another aspect of the present specification include the binder for a secondary battery anode, which is excellent in adhesion and resilience against the volume expansion and contraction of silicon in a state of being wetted by an electrolyte, and thus can implement a high-capacity, high-performance, and long-lifespan secondary battery.

The secondary battery according to still another aspect of the present specification can exhibit high-capacity, high-performance, and long-lifespan characteristics. [36] The effects of one aspect of the present specification are not limited to the effects described above, and should be understood as including all effects that can be inferred from the configurations described in the detailed description or claims of the present specification.

### DESCRIPTION OF DRAWINGS

FIG. 1 is a result of charge/discharge efficiency evaluation for one embodiment and a comparative example of the present specification.

FIG. 2 is a result of rate capability evaluation for one embodiment and a comparative example of the present specification.

### MODES OF THE INVENTION

Hereinafter, one aspect of the present specification will be described with reference to the accompanying drawings.

However, the description of the present specification may be embodied in many different forms and should not be construed as limited to the embodiments set forth herein.

And, in the drawings, parts irrelevant to the description are omitted to clearly describe one aspect of the present specification, and similar reference numerals are attached to similar parts throughout the specification.

Throughout the specification, when a part is referred to as being “connected” to another part, this includes not only cases of being “directly connected” but also cases of being “indirectly connected” with another member interposed therebetween.

In addition, when a part is referred to as “comprising” a certain component, it means that it can further include other components, not excluding other components, unless specifically stated to the contrary.

When a range of numerical values is described in the present specification, unless its specific range is stated otherwise, the value has the precision of the significant figures provided according to the standard rules in chemistry for significant figures.

For example, 10 includes the range of 5.0 to 14.9, and the number 10.0 includes the range of 9.50 to 10.49.

Hereinafter, one embodiment of the present specification will be described in detail with reference to the accompanying drawings.

Binder for Secondary Battery Anode A binder for a secondary battery anode according to one aspect of the present specification includes an aromatic vinyl-conjugated diene-based rubber crosslinked by polyalkylene glycol.

The binder for a secondary battery anode includes the aromatic vinyl-conjugated diene-based rubber crosslinked by polyalkylene glycol, and thus, compared to an uncrosslinked aromatic vinyl-conjugated diene-based rubber binder, it is excellent in adhesion and resilience against the volume expansion and contraction of silicon in a state of being wetted by an electrolyte, and can exhibit excellent effects in ion conductivity, rate capability, and lifespan characteristics.

The development of conventional binders for secondary battery anodes has been carried out by methods of improving the adhesion of the binder itself, but this adhesion evaluation of the binder corresponds to the characteristics of the pure polymer not exposed to the electrolyte.

The physical properties of the binder required for the quality of the secondary battery, especially for lifespan characteristics, are adhesion and resilience against repetitive motion in a state of being wetted by an electrolyte.

The binder for a secondary battery anode is a crosslinked binder including an aromatic vinyl-conjugated diene-based rubber crosslinked by polyalkylene glycol, and by forming crosslinks by covalent bonds between the aromatic vinyl-conjugated diene-based rubber binders, the dry adhesion does not increase significantly, but it prevents the phenomenon of the binder dissociating from the active material in a state of being wetted by the electrolyte, and increases resilience, consequently exhibiting excellent effects in ion conductivity, rate capability, and lifespan characteristics.

The aromatic vinyl-conjugated diene-based rubber crosslinked by polyalkylene glycol can improve the lifespan characteristics of the secondary battery by maximizing resilience as the actions of the rigid polymer and the elastic polymer are organically connected.

The polyalkylene glycol may be one selected from the group consisting of polyethylene glycol, polypropylene glycol, polybutylene glycol, polypentylene glycol, polyhexylene glycol, polytrimethylene glycol, polytetramethylene glycol, polypentamethylene glycol, polyhexamethylene glycol, and combinations of two or more thereof, but is not limited thereto.

The molecular weight of the polyalkylene glycol may be 300˜1,500 g/mol. For example, it may be 300 g/mol, 400 g/mol, 500 g/mol, 600 g/mol, 700 g/mol, 800 g/mol, 900 g/mol, 1,000 g/mol, 1,100 g/mol, 1,200 g/mol, 1,300 g/mol, 1,400 g/mol, 1,500 g/mol, or a range between any two of these values, and preferably may be 400˜800 g/mol.

If the molecular weight of the polyalkylene glycol is less than the above range, less crosslinking occurs between the aromatic vinyl-conjugated diene-based rubbers, and the adhesive strength, charge/discharge efficiency, and rate capability of the binder for a secondary battery anode may be degraded.

The method for preparing the polyalkylene glycol is not particularly limited, but, for example, it can be prepared by an addition reaction of an alkylene oxide in the presence of a catalyst.

At this time, as an initiator, a polyhydric alcohol such as triethanolamine or sorbitol may be used.

As the catalyst, an alkali metal hydroxide catalyst such as potassium hydroxide may be used, but is not limited thereto. The polyalkylene glycol may be a 3- to 6-valent polyalkylene glycol.

For example, it may be a 3-valent, 4-valent, or 6-valent polyalkylene glycol. The term ‘n-valent polyalkylene glycol’ as used in the present specification means a polyalkylene glycol in which the number of hydroxy groups in the molecule is n.

For example, 6-valent polypropylene glycol means a polypropylene glycol in which the number of hydroxy groups in the molecule is 6.

As the number of hydroxy groups in the molecule of the polyalkylene glycol increases, the adhesion of the aromatic vinyl-conjugated diene-based rubber crosslinked thereby may increase.

The gel content of the aromatic vinyl-conjugated diene-based rubber may be 90% or more.

For example, it may be 90% or more, 91% or more, 92% or more, 93% or more, 94% or more, 95% or more, 96% or more, 97% or more, or 98% or more.

If the gel content of the aromatic vinyl-conjugated diene-based rubber is less than the above range, the degree of internal crosslinking is lowered, and the adhesive strength of the binder for a secondary battery anode may be degraded.

The aromatic vinyl-conjugated diene-based rubber may be an aromatic vinyl-conjugated diene-based latex including carboxyl groups.

The aromatic vinyl-conjugated diene-based rubber may be an aromatic vinyl-conjugated diene-based rubber having a core-shell structure.

The core of the aromatic vinyl-conjugated diene-based rubber has elasticity and can provide excellent resilience in the electrolyte of the secondary battery.

The core of the aromatic vinyl-conjugated diene-based rubber may include (a1) a unit derived from a conjugated diene-based monomer, (a2) a unit derived from an aromatic vinyl-based monomer, (a3) a unit derived from an ethylenically unsaturated nitrile monomer or an alkyl ester-based monomer, and (a4) a unit derived from an ethylenically unsaturated acid monomer.

The core of the aromatic vinyl-conjugated diene-based rubber may include, based on the total weight of the aromatic vinyl-conjugated diene-based rubber: (a1) 1˜15 wt % of a unit derived from a conjugated diene-based monomer; (a2) 5˜20 wt % of a unit derived from an aromatic vinyl-based monomer; (a3) 0˜20 wt % of a unit derived from an ethylenically unsaturated nitrile monomer or an alkyl ester-based monomer; and (a4) 0˜20 wt % of a unit derived from an ethylenically unsaturated acid monomer.

The core of the aromatic vinyl-conjugated diene-based rubber may include 1˜15 wt % of the unit derived from a conjugated diene-based monomer, based on the total weight of the aromatic vinyl-conjugated diene-based rubber.

For example, it may be included in an amount of 1 wt %, 2 wt %, 3 wt %, 4 wt %, 5 wt %, 6 wt %, 7 wt %, 8 wt %, 9 wt %, 10 wt %, 11 wt %, 12 wt %, 13 wt %, 14 wt %, 15 wt %, or a range between any two of these values.

When the content of the unit derived from a conjugated diene-based monomer included in the core of the aromatic vinyl-conjugated diene-based rubber satisfies the above range, it exhibits volume expansion characteristics at high pH (e.g., pH 9 or higher), and excellent binder stability can be secured in the range of pH 5 or higher and 8 or lower.

The core of the aromatic vinyl-conjugated diene-based rubber may include 5˜20 wt % of the unit derived from an aromatic vinyl-based monomer, based on the total weight of the aromatic vinyl-conjugated diene-based rubber.

For example, it may be included in an amount of 5 wt %, 6 wt %, 7 wt %, 8 wt %, 9 wt %, 10 wt % 11 wt %, 12 wt %, 13 wt %, 14 wt %, 15 wt %, 16 wt %, 17 wt %, 18 wt %, 19 wt %, 20 wt %, or a range between any two of these values.

When the content of the unit derived from an aromatic vinyl-based monomer included in the core of the aromatic vinyl-conjugated diene-based rubber satisfies the above range, it exhibits volume expansion characteristics at high pH (e.g., pH 9 or higher), and excellent binder stability can be secured in the range of pH 5 or higher and 8 or lower.

The core of the aromatic vinyl-conjugated diene-based rubber may include 0˜20 wt % of the unit derived from an ethylenically unsaturated nitrile monomer or an alkyl ester-based monomer, based on the total weight of the aromatic vinyl-conjugated diene-based rubber.

For example, it may be included in an amount of 0 wt %, 1 wt %, 2 wt %, 3 wt %, 4 wt %, 5 wt %, 6 wt %, 7 wt %, 8 wt %, 9 wt %, 10 wt %, 11 wt %, 12 wt %, 13 wt %, 14 wt %, 15 wt %, 16 wt %, 17 wt %, 18 wt %, 19 wt %, 20 wt %, or a range between any two of these values.

When the content of the unit derived from an ethylenically unsaturated nitrile monomer or an alkyl ester-based monomer included in the core of the aromatic vinyl-conjugated diene-based rubber satisfies the above range, it exhibits volume expansion characteristics at high pH (e.g., pH 9 or higher), and excellent binder stability can be secured in the range of pH 5 or higher and 8 or lower.

The core of the aromatic vinyl-conjugated diene-based rubber may include 0˜20 wt % of the unit derived from an ethylenically unsaturated acid monomer, based on the total weight of the aromatic vinyl-conjugated diene-based rubber.

For example, it may be included in an amount of 0 wt %, 1 wt %, 2 wt %, 3 wt %, 4 wt %, 5 wt %, 6 wt %, 7 wt %, 8 wt %, 9 wt %, 10 wt %, 11 wt %, 12 wt %, 13 wt %, 14 wt %, 15 wt %, 16 wt %, 17 wt %, 18 wt %, 19 wt %, 20 wt %, or a range between any two of these values.

When the content of the unit derived from an ethylenically unsaturated acid monomer included in the core of the aromatic vinyl-conjugated diene-based rubber satisfies the above range, it exhibits volume expansion characteristics at high pH (e.g., pH 9 or higher), and excellent binder stability can be secured in the range of pH 5 or higher and 8 or lower.

The unit derived from an ethylenically unsaturated acid monomer included in the core of the aromatic vinyl-conjugated diene-based rubber may include a unit derived from itaconic acid.

The shell of the aromatic vinyl-conjugated diene-based rubber exhibits hydrophilicity and can provide strong adhesion by hydrogen bonding.

The shell of the aromatic vinyl-conjugated diene-based rubber may include a unit derived from a conjugated diene-based monomer, a unit derived from an aromatic vinyl-based monomer, a unit derived from an alkyl ester-based monomer, and a unit derived from an ethylenically unsaturated acid monomer.

The shell of the aromatic vinyl-conjugated diene-based rubber may include, based on the total weight of the aromatic vinyl-conjugated diene-based rubber: (b1) 10˜40 wt % of a unit derived from a conjugated diene-based monomer; (b2) 20˜40 wt % of a unit derived from an aromatic vinyl-based monomer; (b3) 1˜30 wt % of a unit derived from an alkyl ester-based monomer; and (b4) 0˜10 wt % of a unit derived from an ethylenically unsaturated acid monomer.

The shell of the aromatic vinyl-conjugated diene-based rubber may include 10˜40 wt % of the unit derived from a conjugated diene-based monomer, based on the total weight of the aromatic vinyl-conjugated diene-based rubber.

For example, it may be included in an amount of 10 wt %, 11 wt %, 12 wt %, 13 wt %, 14 wt %, 15 wt %, 16 wt %, 17 wt %, 18 wt %, 19 wt %, 20 wt %, 21 wt %, 22 wt %, 23 wt %, 24 wt %, 25 wt %, 26 wt %, 27 wt %, 28 wt %, 29 wt %, 30 wt %, 31 wt %, 32 wt %, 33 wt %, 34 wt %, 35 wt %, 36 wt %, 37 wt %, 38 wt %, 39 wt %, 40 wt %, or a range between any two of these values.

When the content of the unit derived from a conjugated diene-based monomer included in the shell of the aromatic vinyl-conjugated diene-based rubber satisfies the above range, rubber characteristics can be maintained, and excellent resilience can be secured in the secondary battery electrolyte.

The shell of the aromatic vinyl-conjugated diene-based rubber may include 20˜40 wt % of the unit derived from an aromatic vinyl-based monomer, based on the total weight of the aromatic vinyl-conjugated diene-based rubber.

For example, it may be included in an amount of 20 wt %, 21 wt %, 22 wt %, 23 wt %, 24 wt %, 25 wt %, 26 wt %, 27 wt %, 28 wt %, 29 wt %, 30 wt %, 31 wt %, 32 wt %, 33 wt %, 34 wt %, 35 wt %, 36 wt %, 37 wt %, 38 wt %, 39 wt %, 40 wt %, or a range between any two of these values.

When the content of the unit derived from an aromatic vinyl-based monomer included in the shell of the aromatic vinyl-conjugated diene-based rubber satisfies the above range, rubber characteristics can be maintained, and excellent resilience can be secured in the secondary battery electrolyte.

The shell of the aromatic vinyl-conjugated diene-based rubber may include 1˜30 wt % of the unit derived from an alkyl ester-based monomer, based on the total weight of the aromatic vinyl-conjugated diene-based rubber.

For example, it may be included in an amount of 1 wt %, 2 wt %, 3 wt %, 4 wt %, 5 wt %, 6 wt %, 7 wt %, 8 wt %, 9 wt %, 10 wt %, 11 wt %, 12 wt %, 13 wt %, 14 wt %, 15 wt %, 16 wt %, 17 wt %, 18 wt %, 19 wt %, 20 wt %, 21 wt %, 22 wt %, 23 wt %, 24 wt %, 25 wt %, 26 wt %, 27 wt %, 28 wt %, 29 wt %, 30 wt %, or a range between any two of these values.

When the content of the unit derived from an alkyl ester-based monomer included in the shell of the aromatic vinyl-conjugated diene-based rubber satisfies the above range, rubber characteristics can be maintained, and excellent resilience can be secured in the secondary battery electrolyte.

The shell of the aromatic vinyl-conjugated diene-based rubber may include 0˜10 wt % of the unit derived from an ethylenically unsaturated acid monomer, based on the total weight of the aromatic vinyl-conjugated diene-based rubber.

For example, it may be included in an amount of 0 wt %, 1 wt %, 2 wt %, 3 wt %, 4 wt %, 5 wt %, 6 wt %, 7 wt %, 8 wt %, 9 wt %, 10 wt %, or a range between any two of these values.

When the content of the unit derived from an ethylenically unsaturated acid monomer included in the shell of the aromatic vinyl-conjugated diene-based rubber satisfies the above range, rubber characteristics can be maintained, and excellent resilience can be secured in the secondary battery electrolyte.

The weight ratio of the core and the shell of the aromatic vinyl-conjugated diene-based rubber may be 1:0.5˜10.

For example, it may be 1:0.5, 1:1, 1:2, 1:3, 1:4, 1:5, 1:6, 1:7, 1:8, 1:9, 1:10, or a range between any two of these weight ratios.

The core and the shell have a difference in hydrophilicity, and due to this, the positions of the core and the shell are inverted by a core-shell inversion phenomenon during the emulsion polymerization process.

At this time, the relatively hydrophilic core (which consequently becomes the shell) improves the adhesion between the current collector (copper foil) and the active material, and the relatively less hydrophilic shell (which consequently becomes the core) improves resilience according to the inherent characteristics of the aromatic vinyl-conjugated diene-based rubber.

When the weight ratio of the core and the shell of the aromatic vinyl-conjugated diene-based rubber satisfies the above range, adhesion and resilience can be secured in a balanced manner.

The conjugated diene-based monomer may be one selected from the group consisting of 1,3-butadiene, 2,3-dimethyl-1,3-butadiene, 2-ethyl-1,3-butadiene, 1,3-pentadiene, and combinations of two or more thereof, but is not limited thereto.

The aromatic vinyl-based monomer may be one selected from the group consisting of styrene, α-methylstyrene, 2-methylstyrene, 3-methylstyrene, 4-methylstyrene, 2,4-dimethylstyrene, 2,4-diisopropylstyrene, 4-propylstyrene, 4-cyclohexylstyrene, 4-(p-methylphenyl)styrene, 5-tert-butyl-2-methylstyrene, tert-butoxystyrene, 2-tert-butylstyrene, 3-tert-butylstyrene, 4-tert-butylstyrene, N,N-dimethylaminoethylstyrene, 1-vinyl-5-hexylnaphthalene, 1-vinylnaphthalene, divinylnaphthalene, divinylbenzene, trivinylbenzene, vinylbenzyldimethylamine, (4-vinylbenzyl)dimethylaminoethyl ether, vinylpyridine, vinylxylene, diphenylethylene, halogen-substituted styrene, and combinations of two or more thereof, but is not limited thereto.

The ethylenically unsaturated nitrile monomer may be one selected from the group consisting of acrylonitrile, methacrylonitrile, fumaronitrile, α-chloronitrile, α-cyanoethyl acrylonitrile, and combinations of two or more thereof, but is not limited thereto.

The alkyl ester-based monomer may be one selected from the group consisting of methyl methacrylate, ethyl methacrylate, butyl methacrylate, methyl acrylate, ethyl acrylate, butyl acrylate, and combinations of two or more thereof, but is not limited thereto.

The ethylenically unsaturated acid monomer may be one selected from the group consisting of acrylic acid, methacrylic acid, itaconic acid, maleic acid, fumaric acid, maleic anhydride, citraconic anhydride, styrene sulfonic acid, monobutyl fumarate, monobutyl maleate, mono-2-hydroxypropyl maleate, and combinations of two or more thereof, but is not limited thereto.

The method for preparing the aromatic vinyl-conjugated diene-based rubber is not particularly limited, but, for example, it may be prepared by a method of polymerizing a core monomer mixture including (a1) a conjugated diene-based monomer, (a2) an aromatic vinyl-based monomer, (a3) an ethylenically unsaturated nitrile monomer or an alkyl ester-based monomer, and (a4) an ethylenically unsaturated acid monomer to prepare a copolymer core, and then polymerizing a shell monomer mixture including (b1) a conjugated diene-based monomer, (b2) an aromatic vinyl-based monomer, (b3) an alkyl ester-based monomer, and (b4) an ethylenically unsaturated acid monomer in the presence of the copolymer core to form a copolymer shell on the surface of the copolymer core.

The polymerization of the core monomer mixture and the polymerization of the shell monomer mixture may each be independently performed by emulsion polymerization, and the emulsion polymerization may be performed in the presence of an initiator, a reducing agent, an emulsifier, and a molecular weight modifier.

As the initiator, a persulfate-based water-soluble initiator may be used, and for example, potassium persulfate, sodium persulfate, ammonium persulfate, etc., may be used, but it is not limited thereto.

As the reducing agent, for example, sodium bisulfide, etc., may be used, but it is not limited thereto.

As the emulsifier, a sulfate-based or sulfide-based anionic emulsifier may be used, and for example, sodium dodecyl benzene sulfonate (DBS-Na), sodium lauryl sulfate, sodium dodecyl diphenyl oxide disulfonate, etc., may be used, but it is not limited thereto.

As the molecular weight modifier, a mercaptan-based molecular weight modifier may be used, and for example, t-dodecyl mercaptan, n-dodecyl mercaptan, or octyl mercaptan may be used, but it is not limited thereto.

The molecular weight and gel content of the aromatic vinyl-conjugated diene-based rubber can be controlled by adjusting the type and amount of the molecular weight modifier used.

The aromatic vinyl-conjugated diene-based rubber crosslinked by polyalkylene glycol may be prepared by mixing the aromatic vinyl-conjugated diene-based rubber and the polyalkylene glycol in a weight ratio of 90˜99.5:0.5˜10.

For example, it may be prepared by mixing in a weight ratio of 90:10, 91:9, 92:8, 93:7, 94:6, 95:5, 96:4, 97:3, 98:2, 99:1, 99.5:0.5, or a range between any two of these weight ratios.

Anode Mixture for Secondary Battery An anode mixture for a secondary battery according to another aspect of the present specification includes the aforementioned binder for a secondary battery anode; and an anode active material. The anode mixture for a secondary battery includes the binder for a secondary battery anode, which is excellent in adhesion and resilience against the volume expansion and contraction of silicon in a state of being wetted by an electrolyte, and thus can be applied to the manufacture of a high-capacity, high-performance, and long-lifespan secondary battery.

The anode mixture for a secondary battery may include a binder in which polyacrylic acid or carboxymethyl cellulose is mixed with the aforementioned binder for a secondary battery anode.

For example, it may include a mixture of the aforementioned binder for a secondary battery anode and polyacrylic acid as a binder.

The anode active material may be one or more selected from the group consisting of silicon, a silicon oxide represented by the formula SiOₓ (0.5≤x≤1.5), a silicon-based alloy, and a mixture of these with a carbon-based material, but is not limited thereto.

The anode mixture for a secondary battery may further include a conductive material, a filler, etc., as needed.

The conductive material is for imparting conductivity to the anode, and examples thereof include graphite such as natural graphite or artificial graphite; carbon black such as carbon black, acetylene black, Ketjen black, channel black, furnace black, lamp black, thermal black; conductive fibers such as carbon fibers or metal fibers; metal powders such as carbon fluoride, aluminum, nickel powder; conductive whiskers such as zinc oxide, potassium titanate; conductive metal oxides such as titanium oxide; or conductive materials such as polyphenylene derivatives, or high-functional nano-carbons such as carbon nanotubes, graphene, but it is not limited thereto.

The filler is for suppressing the expansion of the anode, and olefin-based polymers such as polyethylene, polypropylene; or fibrous materials such as glass fibers, carbon fibers may be used, but it is not limited thereto.

Anode An anode according to still another aspect of the present specification includes: an anode mixture layer including the aforementioned anode mixture for a secondary battery; and an anode current collector layer. The anode includes the binder for a secondary battery anode, which is excellent in adhesion and resilience against the volume expansion and contraction of silicon in a state of being wetted by an electrolyte, and thus can be applied to the manufacture of a high-capacity, high-performance, and long-lifespan secondary battery.

The anode may be manufactured by applying the aforementioned anode mixture onto an anode current collector layer, followed by drying and rolling.

The anode current collector layer may include, for example, copper, stainless steel, aluminum, nickel, titanium, or an alloy thereof, but is not limited thereto.

Secondary Battery A secondary battery according to still another aspect of the present specification may include: the aforementioned anode; a cathode; and an electrolyte layer.

The secondary battery includes the binder for a secondary battery anode, which is excellent in adhesion and resilience against the volume expansion and contraction of silicon in a state of being wetted by an electrolyte, and thus can exhibit high-capacity, high-performance, and long-lifespan characteristics.

The cathode and the electrolyte layer may include components that are generally well-known.

Hereinafter, embodiments of the present specification will be described in more detail. However, the following experimental results describe only representative experimental results among the above embodiments, and the scope and content of the present specification cannot be interpreted as being reduced or limited by the embodiments and the like.

The respective effects of various implementations of the present specification that are not explicitly presented below will be specifically described in the corresponding parts.

### Manufacturing Example 1

A core monomer mixture consisting of 6 parts by weight of butadiene, 14 parts by weight of styrene, 2 parts by weight of acrylonitrile, 1.0 part by weight of acrylic acid, and 2 parts by weight of itaconic acid was introduced into a reaction vessel, and 1.2 parts by weight of potassium persulfate as an initiator, 0.4 parts by weight of sodium bisulfide as a reducing agent, 0.2 parts by weight of sodium dodecyl benzene sulfonate as an emulsifier, and 0.1 parts by weight of t-dodecyl mercaptan as a molecular weight modifier were introduced.

A reaction was carried out at a polymerization temperature of 65° C. for 1 hour to obtain a copolymer core.

In the presence of the copolymer core, a shell monomer mixture consisting of 32 parts by weight of butadiene, 37.5 parts by weight of styrene, 5 parts by weight of methyl methacrylate, and 0.5 parts by weight of acrylic acid was introduced, and 0.15 parts by weight of t-dodecyl mercaptan as a molecular weight modifier was continuously introduced over 7 hours.

After reacting at a polymerization temperature of 70° C. for 3.5 hours, a reaction was carried out at a polymerization temperature of 75° C. for 3.5 hours to form a copolymer shell on the surface of the copolymer core.

After being left at a polymerization temperature of 80° C. for 4 hours, NaOH was added and titrated to pH 7.0 to obtain a core-shell structure styrene-butadiene-based binder.

### Manufacturing Example 2

A core monomer mixture consisting of 4 parts by weight of butadiene, 15.5 parts by weight of styrene, 2 parts by weight of methyl methacrylate, 0.5 parts by weight of acrylic acid, and 3 parts by weight of itaconic acid was introduced into a reaction vessel, and 1.2 parts by weight of potassium persulfate as an initiator, 0.4 parts by weight of sodium bisulfide as a reducing agent, 0.2 parts by weight of sodium dodecyl benzene sulfonate as an emulsifier, and 0.1 parts by weight of t-dodecyl mercaptan as a molecular weight modifier were introduced.

A reaction was carried out at a polymerization temperature of 65° C. for 1 hour to obtain a copolymer core.

In the presence of the copolymer core, a shell monomer mixture consisting of 30 parts by weight of butadiene, 38.5 parts by weight of styrene, 6 parts by weight of methyl methacrylate, and 0.5 parts by weight of acrylic acid was introduced, and 0.15 parts by weight of t-dodecyl mercaptan as a molecular weight modifier was continuously introduced over 7 hours.

After reacting at a polymerization temperature of 70° C. for 3.5 hours, a reaction was carried out at a polymerization temperature of 75° C. for 3.5 hours to form a copolymer shell on the surface of the copolymer core.

After being left at a polymerization temperature of 80° C. for 4 hours, NaOH was added and titrated to pH 7.0 to obtain a core-shell structure styrene-butadiene-based binder.

### Manufacturing Example 3

A core monomer mixture consisting of 4 parts by weight of butadiene, 15.5 parts by weight of styrene, 2 parts by weight of methyl methacrylate, 0.5 parts by weight of acrylic acid, and 3 parts by weight of itaconic acid was introduced into a reaction vessel, and 1.2 parts by weight of potassium persulfate as an initiator, 0.4 parts by weight of sodium bisulfide as a reducing agent, 0.2 parts by weight of sodium dodecyl benzene sulfonate as an emulsifier, and 0.07 parts by weight of t-dodecyl mercaptan as a molecular weight modifier were introduced.

A reaction was carried out at a polymerization temperature of 65° C. for 1 hour to obtain a copolymer core.

In the presence of the copolymer core, a shell monomer mixture consisting of 30 parts by weight of butadiene, 38.5 parts by weight of styrene, 6 parts by weight of methyl methacrylate, and 0.5 parts by weight of acrylic acid was introduced, and 0.10 parts by weight of t-dodecyl mercaptan as a molecular weight modifier was continuously introduced over 7 hours.

After reacting at a polymerization temperature of 70° C. for 3.5 hours, a reaction was carried out at a polymerization temperature of 75° C. for 3.5 hours to form a copolymer shell on the surface of the copolymer core.

After being left at a polymerization temperature of 80° C. for 4 hours, NaOH was added and titrated to pH 7.0 to obtain a core-shell structure styrene-butadiene-based binder.

### Manufacturing Example 4

At a polymerization temperature of 110˜130° C., propylene oxide was subjected to an addition reaction in the presence of a potassium hydroxide catalyst. At this time, triethanolamine was used as an initiator.

After the polymerization was completed, it was neutralized with acid and purified to obtain 3-valent polypropylene glycol.

### Manufacturing Example 5

At a polymerization temperature of 110˜130° C., propylene oxide was subjected to an addition reaction in the presence of a potassium hydroxide catalyst. At this time, sorbitol was used as an initiator. After the polymerization was completed, it was neutralized with acid and purified to obtain 6-valent polypropylene glycol.

### Example 1

The styrene-butadiene-based binder prepared by the method of Manufacturing Example 1 and the 3-valent polypropylene glycol prepared by the method of Manufacturing Example 4 were mixed in a weight ratio of 98:2 to prepare a crosslinked binder.

### Example 2

The styrene-butadiene-based binder prepared by the method of Manufacturing Example 1 and the 6-valent polypropylene glycol prepared by the method of Manufacturing Example 5 were mixed in a weight ratio of 98:2 to prepare a crosslinked binder.

### Example 3

The styrene-butadiene-based binder prepared by the method of Manufacturing Example 2 and the 3-valent polypropylene glycol prepared by the method of Manufacturing Example 4 were mixed in a weight ratio of 98:2 to prepare a crosslinked binder.

### Example 4

The styrene-butadiene-based binder prepared by the method of Manufacturing Example 2 and the 6-valent polypropylene glycol prepared by the method of Manufacturing Example 5 were mixed in a weight ratio of 98:2 to prepare a crosslinked binder.

### Example 5

The styrene-butadiene-based binder prepared by the method of Manufacturing Example 3 and the 3-valent polypropylene glycol prepared by the method of Manufacturing Example 4 were mixed in a weight ratio of 98:2 to prepare a crosslinked binder.

### Example 6

The styrene-butadiene-based binder prepared by the method of Manufacturing Example 3 and the 6-valent polypropylene glycol prepared by the method of Manufacturing Example 5 were mixed in a weight ratio of 98:2 to prepare a crosslinked binder.

### Experimental Example 1: Adhesive Strength Evaluation

The adhesive strengths of the crosslinked binders prepared by the methods of Examples 1 to 4 were evaluated.

The adhesive strengths of the styrene-butadiene-based binders prepared by the methods of Manufacturing Examples 1 and 2 were evaluated by the same method and compared.

Graphite:conductive carbon (Super P):carboxyl-modified methyl cellulose:binder were mixed with water in a ratio of 95:1:2:2, respectively, to make a slurry with a solid content of 45%, and this was used to coat a copper thin film used as a current collector.

An anode plate was manufactured by drying at 180° C. for 1 minute, drying in a 60° C. oven for 2 hours or more, and then roll-pressing with a roll press to a rolling density of 1.6 g/cm³.

The adhesive strength of the manufactured anode plate was measured by the standard 90-degree peel test method. The results are shown in Table 1 below.

TABLE 1

| | Adhesive | |
|---|---|---|
| | Strength (N) | Remarks |
| Example 1 | 1.3009 | 103% compared to |
| | | Manufacturing Example 1 |
| Example 2 | 1.3603 | 108% compared to |
| | | Manufacturing Example 1 |
| Example 3 | 1.3605 | 104% compared to |
| | | Manufacturing Example 2 |
| Example 4 | 1.4116 | 108% compared to |
| | | Manufacturing Example 2 |
| Manufacturing Example 1 | 1.2592 | — |
| Manufacturing Example 2 | 1.3095 | — |

Referring to Table 1, the crosslinked binders prepared by the methods of Examples 1 to 4 showed improved adhesive strength compared to the styrene-butadiene-based binders of Manufacturing Examples 1 and 2.

In particular, the crosslinked binders of Examples 2 and 4, which used the 6-valent polypropylene glycol prepared by the method of Manufacturing Example 5, showed 108% improved adhesive strength compared to Manufacturing Examples 1 and 2, respectively.

### Experimental Example 2: Charge/Discharge Efficiency Evaluation

The charge/discharge efficiency of the crosslinked binder prepared by the method of Example 3 was evaluated.

The charge/discharge efficiency of the styrene-butadiene-based binder prepared by the method of Manufacturing Example 2 was evaluated by the same method and compared.

A 2032 standard coin cell was fabricated using the anode plate prepared in Experimental Example 1 and an NCM523 cathode plate coated on aluminum, and the charge/discharge efficiency was compared at room temperature under 1 C/CC conditions using a WonATech WBCS3000 charge/discharge cycler.

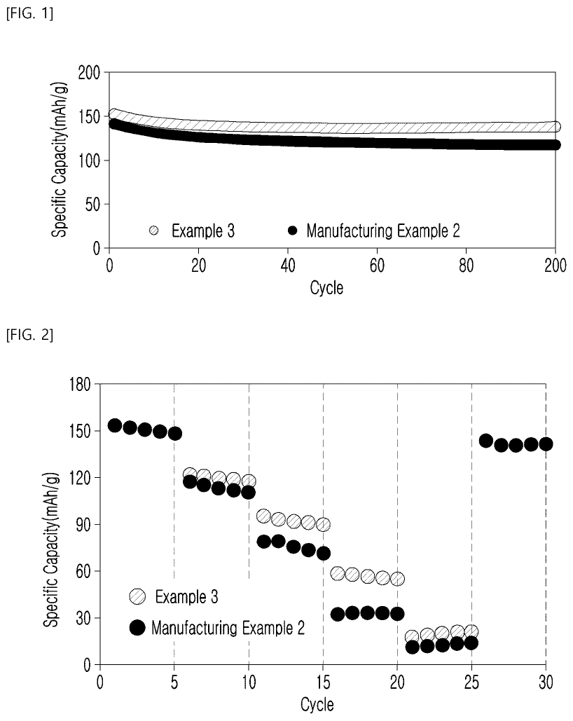

The results are shown in FIG. 1. Referring to FIG. 1, it was confirmed that the crosslinked binder prepared by the method of Example 3 showed an effect of increasing charge/discharge efficiency due to crosslinking, compared to the styrene-butadiene-based binder prepared by the method of Manufacturing Example 2.

### Experimental Example 3: Rate Capability Evaluation

The rate capability of the crosslinked binder prepared by the method of Example 3 was evaluated.

The rate capability of the styrene-butadiene-based binder prepared by the method of Manufacturing Example 2 was evaluated by the same method and compared.

Using the coin cell prepared in Experimental Example 2 and the WBCS3000 charge/discharge cycler, the rate capability was compared by measuring 5 times each at rate conditions of 1C, 3C, 5C, 7C, 10C, and 1C, respectively.

The results are shown in FIG. 2. Referring to FIG. 2, it was confirmed that the crosslinked binder prepared by the method of Example 3 showed an effect of improving rate capability due to crosslinking, compared to the styrene-butadiene-based binder prepared by the method of Manufacturing Example 2.

### Experimental Example 4: Adhesive Strength Evaluation

The adhesive strengths of the crosslinked binders prepared by the methods of Examples 5 and 6 were evaluated.

The adhesive strengths of the styrene-butadiene-based binders prepared by the methods of Manufacturing Examples 2 and 3 were evaluated by the same method and compared.

Graphite:conductive carbon (Super P):carboxyl-modified methyl cellulose:binder were mixed with water in a ratio of 95:1:2:2, respectively, to make a slurry with a solid content of 45%, and this was used to coat a copper thin film used as a current collector.

An anode plate was manufactured by drying at 180° C. for 1 minute, drying in a 60° C. oven for 2 hours or more, and then roll-pressing with a roll press to a rolling density of 1.5˜1.6 g/cm³.

The adhesive strength of the manufactured anode plate was measured by the standard 90-degree peel test method. The results are shown in Table 2 below.

TABLE 2

| | Adhesive | |
|---|---|---|
| | Strength (N) | Remarks |
| Example 5 | 1.3009 | 103% compared to |
| | | Manufacturing Example 3 |
| Example 6 | 1.3603 | 108% compared to |
| | | Manufacturing Example 3 |
| Manufacturing Example 2 | 1.1553 | Gel content 93% |
| Manufacturing Example 3 | 1.2592 | Gel content 98% |

Referring to Table 2, the crosslinked binders prepared by the methods of Examples 5 and 6 showed improved adhesive strength compared to the styrene-butadiene-based binder of Manufacturing Example 3.

In particular, the crosslinked binder of Example 6, which used the 6-valent polypropylene glycol prepared by the method of Manufacturing Example 5, showed 108% improved adhesive strength compared to Manufacturing Example 3.

The styrene-butadiene-based binder of Manufacturing Example 3, in which the gel content was increased to 98% by reducing the amount of molecular weight modifier input compared to Manufacturing Example 2, showed improved adhesive strength compared to the styrene-butadiene-based binder prepared by the method of Manufacturing Example 2.

The foregoing description of the present specification is for illustrative purposes, and those of ordinary skill in the art to which one aspect of the present specification pertains will be able to understand that modifications can be easily made into other specific forms without changing the technical spirit or essential features described in the present specification.

Therefore, it should be understood that the embodiments described above are illustrative in all respects and not restrictive.

For example, each component described as a single type may be implemented in a distributed manner, and likewise, components described as being distributed may also be implemented in a combined form.

The scope of the present specification is indicated by the claims set forth below, and it should be interpreted that all changes or modified forms derived from the meaning and scope of the claims and their equivalent concepts are included in the scope of the present specification.

1. A binder for a secondary battery anode, comprising an aromatic vinyl-conjugated diene-based rubber crosslinked by polyalkylene glycol.

2. The binder for a secondary battery anode according to claim 1, wherein the polyalkylene glycol is one selected from the group consisting of polyethylene glycol, polypropylene glycol, polybutylene glycol, polypentylene glycol, polyhexylene glycol, polytrimethylene glycol, polytetramethylene glycol, polypentamethylene glycol, polyhexamethylene glycol, and combinations of two or more thereof.

3. The binder for a secondary battery anode according to claim 1, wherein the gel content of the aromatic vinyl-conjugated diene-based rubber is 90% or more.

4. The binder for a secondary battery anode according to claim 1, wherein the aromatic vinyl-conjugated diene-based rubber is an aromatic vinyl-conjugated diene-based rubber having a core-shell structure.

5. The binder for a secondary battery anode according to claim 4, wherein the core of the aromatic vinyl-conjugated diene-based rubber comprises, based on the total weight of the aromatic vinyl-conjugated diene-based rubber: (a1) 1˜15 wt % of a unit derived from a conjugated diene-based monomer; (a2) 5˜20 wt % of a unit derived from an aromatic vinyl-based monomer; (a3) 0˜20 wt % of a unit derived from an ethylenically unsaturated nitrile monomer or an alkyl ester-based monomer; and (a4) 0˜20 wt % of a unit derived from an ethylenically unsaturated acid monomer.

6. The binder for a secondary battery anode according to claim 4, wherein the shell of the aromatic vinyl-conjugated diene-based rubber comprises, based on the total weight of the aromatic vinyl-conjugated diene-based rubber: (b1) 10˜40 wt % of a unit derived from a conjugated diene-based monomer; (b2) 20˜40 wt % of a unit derived from an aromatic vinyl-based monomer; (b3) 1˜30 wt % of a unit derived from an alkyl ester-based monomer; and (b4) 0˜10 wt % of a unit derived from an ethylenically unsaturated acid monomer.

7. The binder for a secondary battery anode according to claim 5, wherein the conjugated diene-based monomer is one selected from the group consisting of 1,3-butadiene, 2,3-dimethyl-1,3-butadiene, 2-ethyl-1,3-butadiene, 1,3-pentadiene, and combinations of two or more thereof.

8. The binder for a secondary battery anode according to claim 5, wherein the aromatic vinyl-based monomer is one selected from the group consisting of styrene, α-methylstyrene, 2-methylstyrene, 3-methylstyrene, 4-methylstyrene, 2,4-dimethylstyrene, 2,4-diisopropylstyrene, 4-propylstyrene, 4-cyclohexylstyrene, 4-(p-methylphenyl)styrene, 5-tert-butyl-2-methylstyrene, tert-butoxystyrene, 2-tert-butylstyrene, 3-tert-butylstyrene, 4-tert-butylstyrene, N,N-dimethylaminoethylstyrene, 1-vinyl-5-hexylnaphthalene, 1-vinylnaphthalene, divinylnaphthalene, divinylbenzene, trivinylbenzene, vinylbenzyldimethylamine, (4-vinylbenzyl)dimethylaminoethyl ether, vinylpyridine, vinylxylene, diphenylethylene, halogen-substituted styrene, and combinations of two or more thereof.

9. The binder for a secondary battery anode according to claim 5, wherein the ethylenically unsaturated nitrile monomer is one selected from the group consisting of acrylonitrile, methacrylonitrile, fumaronitrile, α-chloronitrile, α-cyanoethyl acrylonitrile, and combinations of two or more thereof.

10. The binder for a secondary battery anode according to claim 5, wherein the alkyl ester-based monomer is one selected from the group consisting of methyl methacrylate, ethyl methacrylate, butyl methacrylate, methyl acrylate, ethyl acrylate, butyl acrylate, and combinations of two or more thereof.

11. The binder for a secondary battery anode according to claim 5, wherein the ethylenically unsaturated acid monomer is one selected from the group consisting of acrylic acid, methacrylic acid, itaconic acid, maleic acid, fumaric acid, maleic anhydride, citraconic anhydride, styrene sulfonic acid, monobutyl fumarate, monobutyl maleate, mono-2-hydroxypropyl maleate, and combinations of two or more thereof.

12. The binder for a secondary battery anode according to claim 1, wherein the aromatic vinyl-conjugated diene-based rubber crosslinked by polyalkylene glycol is prepared by mixing the aromatic vinyl-conjugated diene-based rubber and the polyalkylene glycol in a weight ratio of 90˜99.5:0.5˜10.

13. An anode mixture for a secondary battery, comprising: the binder for a secondary battery anode of claim 1; and an anode active material.

14. The anode mixture for a secondary battery according to claim 13, wherein the anode active material is one or more selected from the group consisting of silicon, a silicon oxide represented by the formula SiOₓ (0.5≤x≤1.5), a silicon-based alloy, and a mixture of these with a carbon-based material.

15. An anode, comprising: an anode mixture layer comprising the anode mixture for a secondary battery of claim 13; and an anode current collector layer.

16. A secondary battery, comprising: the anode of claim 15; a cathode; and an electrolyte layer.
